(19) United States
(12) Patent Application Publication
(10) Pub. No.: US 2025/0390471 A1
(43) Pub. Date: Dec. 25, 2025

(54) Method for Embedded Vector Databases

(71) Applicant: Alon Glazer, Mackinac Island, MI (US)

(72) Inventor: Alon Glazer, Mackinac Island, MI (US)

(21) Appl. No.: 19/245,356

(22) Filed: Jun. 22, 2025

Related U.S. Application Data
(60) Provisional application No. 63/663,165, filed on Jun. 23, 2024.

(51) Int. Cl. G06F 16/21; G06F 16/22

(52) U.S. Cl. CPC G06F 16/21; G06F 16/2237

(57) ABSTRACT

A method for managing vector data within a vector database is disclosed, encompassing a storage mechanism to store digital representations of vectors with associated metadata characteristics such as length, magnitude, and numerical type. The method includes data fields capable of storing non-vector data, including text, numeric, and general-use memory fields (blob). It features search and retrieval algorithms allowing users to query using both vector and non-vector data characteristics and functions, along with data manipulation mechanisms for modifying stored data, including vectors. The method employs a query language for manipulating and retrieving stored data. Additionally, the method provides application programming interface (API) endpoints for third-party integration and a computer-memory storage mechanism enabling the saving, loading, and transfer of the vector database data between devices and software processes. The database can be run on various platforms, including embedded systems, mobile and handheld devices, robotic devices, vehicles, wearable devices, and Internet-of-Thing devices.

This application is a continuation application of U.S. Provisional Application No. 63/663,165, filed Jun. 23, 2024, and incorporates by reference the disclosure therein.

### FIELD OF INVENTION

The present invention relates to a method for vector databases for embedded systems. More specifically, the present invention relates to a method for data storage, manipulation, and retrieval on an embedded system, including both vector data and non-vector data.

### BACKGROUND OF INVENTION

A vector database is a specialized data storage method designed to efficiently store, manage, and query mathematical vectors. These vectors may act as numerical representations of data, such as text, images, or other digital content, and are used extensively in machine learning and artificial intelligence (AI) applications. Vector databases optimize the storage, retrieval, and manipulation of vector data, enabling efficient execution of operations like similarity searches, clustering, and vector arithmetic. Unlike traditional databases, which primarily manage non-vector-based data such as text strings, numbers, and Boolean values, vector databases are tailored to support complex mathematical computations and high-speed querying of vector-based data. This specialized functionality makes vector databases essential for applications requiring rapid and accurate processing of high-dimensional numerical representations of data.

An embedded system is a specialized computing system that is designed to perform a specific set of functions or tasks, often in a real-time environment with limited resources. Embedded systems encompass a wide spectrum of applications, including but not restricted to mobile devices, web browsers, wearable devices, Internet-of-Things (IoT) devices, vehicles, robots, agricultural machinery, and construction equipment.

The present invention provides a distinct advantage in the storage, manipulation, retrieval, and use of vectors within databases running in embedded systems, edge devices, and client-side devices and software. An edge device is a physical electronic device located at the “edge” of a network, close to the source of data generation. A client-side device is a user's computer, smartphone, or other device that connects to a server to access resource, services, or processing. Furthermore, this innovation presents substantial merits for confidential data applications, such as for utilization of private records, and for devices functioning in regions with constrained connectivity, exemplified by remote terrains, subterranean environments, or enclosed spaces such as trains, aircraft, and automobiles. While the following description primarily focuses on these specific applications, it should be recognized that the applicability of this innovation extends to various other scenarios where the storage, manipulation, retrieval, and use of vectors within embedded databases is required.

In artificial intelligence, numerical vectors find application in representing data, including textual content, visual content, and other digital data. Numerous techniques currently exist for the storage, manipulation, and utilization of these vectors. Conventionally, these methodologies entail the storage, retrieval, modification, and removal of vectors and vector values within software, such as data stores, and software is housed on dedicated servers or computers. Accessing and leveraging these vectors requires either transmission access or physical access to the servers or computers where they are stored. With access to these aforementioned locations, mathematical and algorithmic manipulations can be performed on the vectors. These operations encompass identifying sets and subsets of vectors with mathematical proximity or disparity, as well as determining the lengths, mathematical norms, or mathematical magnitudes of vector subsets. Another process, called vector quantization, involves a series of mathematical operations that adjust the values of a vector to achieve algorithmic benefits while preserving certain characteristics of the original vector, including its relation to other vectors. Facilitating the execution of such operations empowers functionalities akin to those found in search engines and recommendation engines. Furthermore, these operations can enhance generative artificial intelligence platforms by retrieving information for use in a generative process.

One limitation associated with existing methodologies becomes evident when the availability of the software hosted on an off-premises server or computer is constrained. This becomes particularly relevant in scenarios where internet access is restricted or unavailable to the client-side software, as exemplified by rural geographical areas or crowded locations with limited internet bandwidth. In such circumstances, a device seeking to utilize the remotely-stored vectors would encounter an impediment, rendering their utilization either impractical or infeasible.

Another limitation associated with the prior art pertains to scenarios wherein the server or computer used for vector storage and operations experiences suboptimal performance or malfunctions, leading to a domino effect of errors impacting users and interconnected modules. This is commonly referred to as the single-point-of-failure phenomenon. In instances of such occurrences, devices dependent on an operational and fully functional mechanism encounter hindrances as a result of their inability to access the vectors. This predicament can arise due to a multitude of factors, including, but not confined to, software overloads, misconfigurations, hardware outages or malfunctions, and instances of cybersecurity breaches.

Additional limitations of the current methodologies emerge concerning the exposure of the server or computer software to private or confidential data. To facilitate operations involving vectors, the software deployed on the server or computer responsible for these operations requires access to the vectors. In instances where the vectors encompass sensitive information, the existing methodologies can inadvertently expose such data to unauthorized entities, such as a third-party service provider. For instance, in situations where vectors represent or include sensitive data and are stored off-premises, the original creator of these vectors lacks the direct means to oversee the software for potential external access, data breaches, or potential theft.

Further limitations of current methodologies involve querying vector data using filtering mechanisms which rely on non-vector data. In databases, querying is the act of retrieving data and then filtering it using specific conditions. Structured Query Language (SQL) is a standard framework for performing queries and managing data in relational databases. Most existing vector databases are optimized for querying using vector data specifically and do not support filtering mechanisms based on other data types. As a result, when using such vector databases, vector data is often retrieved separately from non-vector data, which may be stored on a different database. After both types of data are retrieved, they must be combined and filtered again to ensure correct processing of the original retrieval request.

### SUMMARY OF THE INVENTION

This summary is intended to disclose the present invention, a method for vector databases operating in embedded systems, edge devices, and client-side devices and software. The embodiments and descriptions serve to illustrate the invention and its utility and are not intended to limit the invention or its use. One objective of the present invention is to provide a method for a vector database on embedded systems in a manner having advantages in one or more of the above respects.

The present invention relates to a method for storing and managing vector data within a vector database. The vector database of the present invention stores digital representations of vectors, along with metadata fields associated with each vector, detailing characteristics like length, magnitude, and numerical type. Additionally, the vector database incorporates data fields capable of storing non-vector data, including text fields, numeric fields, and general use memory (blob) fields.

The invention uses search and retrieval algorithms enabling users to query the vector database based on both vector and non-vector data characteristics and relations. As an example, and not by way of limitation, relational queries on vector data may include dot-product operations, cosine-similarity operations, distance functions, length comparisons, magnitude comparisons, or combinations of such operations. The invention also includes data manipulation mechanisms allowing updates and modifications to stored data, including vectors, as well as a query language for efficient data manipulation, retrieval, and filtering.

The method has an application programming interface (API) to facilitate third-party integration. As an example, and not by way of limitation, these APIs may comprise various programming language libraries commonly used on embedded systems, such as Python, Java, JavaScript, C, C++, and other common programming languages. The method integrates a computer-memory storage mechanism enabling the functionalities of saving the vector database for later use, loading the vector database from a saved location, supporting utilization by different software processes, and enabling transfer between hardware devices.

The invention offers flexibility by providing mechanisms for deploying the vector database on various platforms, including mobile devices, handheld devices, web browsers, robotic devices, vehicles, wearable devices, such as smart watches and mobile headsets, and other Internet-of-Things (IoT) devices and embedded systems.

The method offers flexibility in representing or storing vector values using different data types such as integers, floating-point values, or Boolean values. It includes mechanisms for manipulating the representation or storage of vector values from one form to another, thereby enhancing versatility in data handling.

### DESCRIPTION OF THE INVENTION AND PREFERRED EMBODIMENTS

The present invention includes methods of managing vector data within a vector database in an embedded system. These methods comprise: a vector database designed for integration into embedded systems; the storage, querying, modification, and management of vector data and associated metadata; the storage, querying, modification, and management of non-vector data; and search and retrieval algorithms for vector data and non-vector data.

The method of the present invention is further comprised of a plurality of steps for managing vector data within an embedded system comprising: mechanisms for the storage, querying, retrieval, modification, insertion, deletion, and management of vector data and non-vector data; components for running the vector database on an embedded system; steps for integrating Application Programming Interface (API) endpoints; steps for data persistence and recovery; steps for data transfer between devices; steps allowing for concurrent access to the vector database; and steps for performing mathematical operations and functions on vectors. The embedded system described may include a mobile device, a handheld device, a robotic apparatus, a vehicle, a wearable device, a mobile headset, or other Internet-of-Things devices and embedded systems.

The present invention is applicable to a vector database used by an embedded system with limited internet access. Restricted internet access is often associated with remote or rural geographical areas, crowded locations with limited internet bandwidth, or physical areas with electromagnetic interference. In such areas, embedded systems may require vector data to perform specific tasks. For example, a vehicle operating in a rural area may require vector data for performing geolocation or mapping. In this and other examples, the present invention provides a method of performing vector operations on the embedded device. By using a vector database that stores data locally and runs on-device, an internet connection is not required. For instance, the vehicle in this example can store identifying characteristics of objects alongside geographic vector data to perform geolocation and mapping tasks, such as through similarity search and triangulation. In this embodiment, using the vector database on the embedded system eliminates the reliance on an internet connection to perform vector-based operations.

In another example embodiment of the present invention, it becomes evident that running a vector database on an embedded system can mitigate the effects of a single-point-of-failure phenomenon. The single-point-of-failure phenomenon occurs in scenarios where a centralized server or computer used for vector storage and operations experiences suboptimal performance or malfunctions. In this embodiment, there is provided a method for deploying different instances of the vector database on separate embedded systems independently. Each embedded system may need to perform tasks requiring vector data and vector operations. Traditionally, these systems send vector-based operation requests to a centralized system for processing. Storing the vector data on the embedded system and performing vector operations locally allows the embedded systems to continue functioning even if the centralized system fails. For example, robotic devices on an assembly line can utilize vector data for kinematics functionality, object detection functionality, or planning functionality without consulting a central computer, thereby reducing the computational overhead and internet bandwidth overhead associated with having numerous embedded systems in a single location. Similarly, a fleet of vehicles can operate independently even if their geolocation provider becomes unavailable.

According to another embodiment of the present invention, there is provided a method for using a vector database on an embedded system with private or confidential data, such as a mobile or wearable device. Mobile and wearable devices include, but are not limited to, smartphones, smartwatches, cameras, and mobile headsets. For example, mobile devices are often used by individuals to interact with personalized data and information that may be private or unique. Such information may include, but is not limited to, personal emails, photos, documents, phone call records, audio recordings, personal health records, and other records of social or environmental interactions. In this embodiment, vector data represents said personalized information. This vector data is stored on the mobile device and queried using the vector database which runs on the mobile device. For example, vector data representing personalized information may be used by the vector database to perform operations commonly found in search engines and recommendation algorithms, such as vector-based semantic search. This example embodiment mitigates external access to and leakage of the mobile device user's private or confidential vector data and associated non-vector data by performing storage and query operations locally on the device.

A further embodiment of the present invention provides a method for using a vector database on an embedded system to perform querying and data filtering using both vector data and non-vector data. In many cases, a vector used by an embedded system is usable only if other data associated with it meets certain criteria. In this embodiment, criteria are provided as clauses in a query to the vector database. This enables the vector database to optimize the query for performance and reduces the need for multiple queries which are subsequently parsed using external software. For example, in visual object comparison, the object looks different depending on color and lighting, resulting in different vector representations of the object. A visual object comparison mechanism may filter objects using a clause of current lighting conditions and a vector similarity clause. Similarly, an example semantic search engine may prioritize results based on characteristics such as time, source, or author, amongst others. The semantic search engine may filter results using a clause for result characteristics and a clause for vector distance operations. This embodiment provides a method to query the vector database using both vector operations and non-vector functionality.

It will thus be seen that, while the invention has been described with respect to a number of embodiments, these are set forth merely for purposes of example, and many other variations, modifications, and applications of the invention may be made.

### BRIEF DESCRIPTION OF THE DRAWINGS

FIG. 1 is an interoperation diagram for a vector database integrated into an embedded system.

FIG. 2 is an internal architecture diagram of the vector database.

FIG. 3 is a diagram illustrating how vector data may be stored within the vector database.

FIG. 4 is a diagram showing the insertion of data into the vector database.

FIG. 5 is a diagram showing the deletion of data from the vector database.

FIG. 6 is a diagram showing the modification of data in the vector database.

FIG. 7 is a diagram showing the querying process of the vector database.

FIG. 8 is a diagram showing how a vector may be manipulated within the vector database.

FIG. 9 is a diagram showing a computer readable instruction set for querying the vector database in order to find a nearest-neighboring vector.

FIG. 10 is an interoperation diagram showing the integration of the vector database with an Application Programming Interface (API).

FIG. 11 illustrates the deployment of the vector database on various embedded systems.

FIG. 12 is a diagram demonstrating the use of the vector database on a smartphone.

FIG. 13 is a diagram of the vector database saving and loading data to and from a file.

FIG. 14 is a diagram of a data file supported by the vector database being transferred between different embedded systems.

FIG. 15 is a diagram of multiple programs operating via the API with the vector database.

FIG. 16 is a diagram showing a process for using a vector in the vector database.

FIG. 17 is a diagram showing vector functions for use with the vector database.

FIG. 18 is a diagram showing an example of the vector database as part of a textual search engine on a smartphone.

FIG. 19 is a diagram showing an example of the vector database as part of a recommendation algorithm on a camera.

FIG. 20 is a diagram showing an example of the vector database being used to help position a robotic arm.

FIG. 21 is a diagram showing an example of the vector database being used for geolocation on a vehicle.

### DETAILED DESCRIPTION OF THE DRAWINGS

The present invention discloses a method for managing and manipulating a database containing vector data (“vector database”), operating in embedded systems, edge devices, and client-side devices and software. The illustrated embodiments of the invention are used to show the invention's integration into an embedded system. They also show data storage, manipulation, retrieval, and transfer on an embedded system, including both vector data and non-vector data.

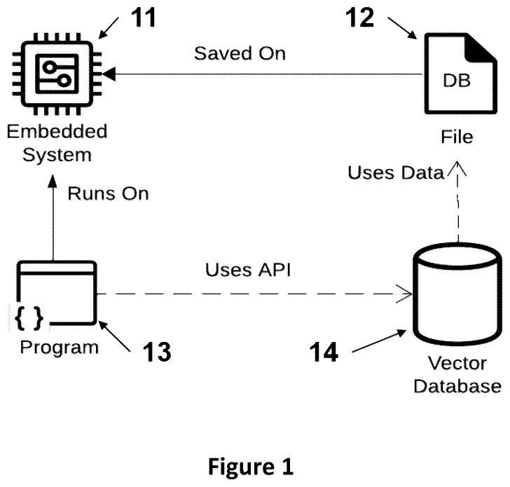

FIG. 1 illustrates an example of the vector database 14 integrated into an embedded system 11. A software program 13 running on the embedded system 11 uses the vector database 14 through Application Programming Interface (API). Vector database 14 uses file 12 to store data. File 12 is saved on embedded system 11.

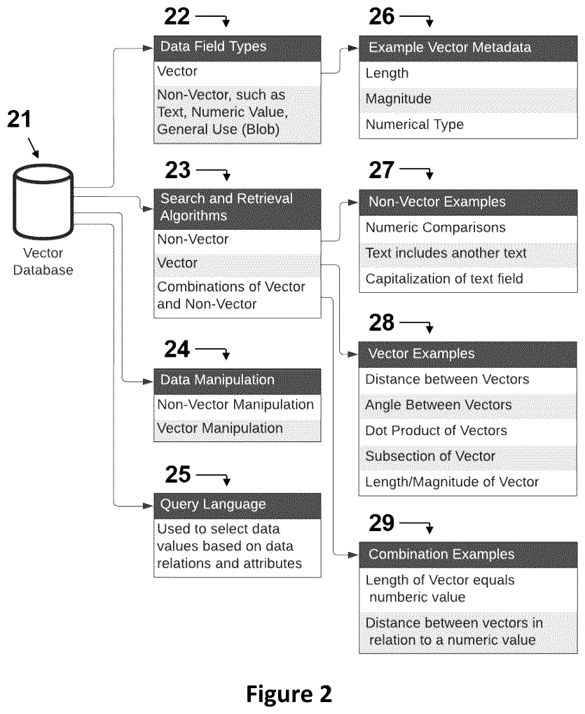

FIG. 2 is an example component diagram showing the internal architecture of the vector database 21. Vector database 21 can store data in different categories of data field types 22, including vector data fields and non-vector data fields, such as text, numeric values, and general purpose (blob) storage. The vector data may include both a vector's numeric values and associated vector metadata 26, such as length, magnitude, and numerical type.

As shown in FIG. 2, the vector database 21 also includes search and retrieval algorithms 23. Examples of search and retrieval algorithms 23 include non-vector algorithms 27, vector algorithms 28, and combinations of both non-vector and vector algorithms 29. Examples of non-vector algorithms 27 include numeric value comparisons, text field searches, and text field capitalization. Examples of vector algorithms 28 include comparing vectors, such as finding the distance between vectors, the angle between vectors, or the dot product of two vectors, or extracting information from a single vector, such as a subsection of a vector, the length of a vector, or the magnitude of a vector. Examples of combinations of both non-vector and vector algorithms 29 include comparing the length of individual vectors to a numeric value or filtering using the distance between vectors in relation to a numeric value.

As shown in FIG. 2, the vector database 21 also includes data manipulation mechanisms 24, including both non-vector manipulation mechanisms and vector manipulation mechanisms, such as data creation, modification, retrieval, deletion, and storage.

The vector database 21 in FIG. 2 also includes a query language 25, which is used to select data values based on data relations and attributes. Selected data can then be manipulated using the data manipulation mechanisms 24 described above.

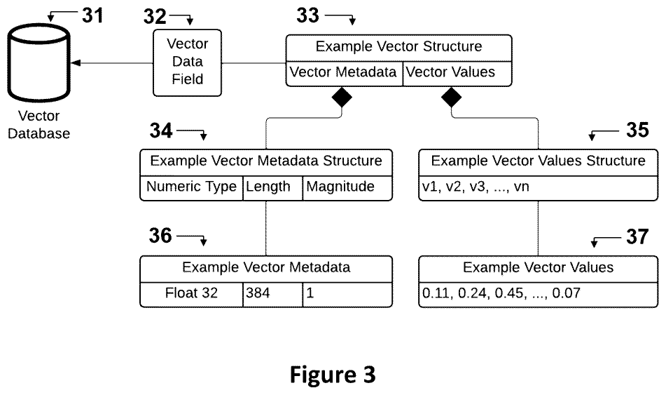

FIG. 3 is a diagram depicting how vector data may be stored within the vector database 31. This diagram shows a vector data field 32 as part of the vector database 31. An example digital structure 33 of the vector data field 32 includes vector metadata and the vector's values. An example of a vector metadata structure 34 contains the numeric type of the vector, the length of the vector, and the magnitude of the vector. An example of the vector metadata 36 which may be stored in the vector metadata structure 34 displays the numeric type as “Float 32”, the length as “384” and the magnitude as “1”. An example of the vector values structure 35 contains the numeric values of the vector, in the form of “v1”, “v2”, “v3”, and so on until “vn”, which is the last value of the vector values. An example of such vector values 37 which may be stored in the vector values structure 35 shows them as “0.11, 0.24, 0.45, . . . , 0.07”.

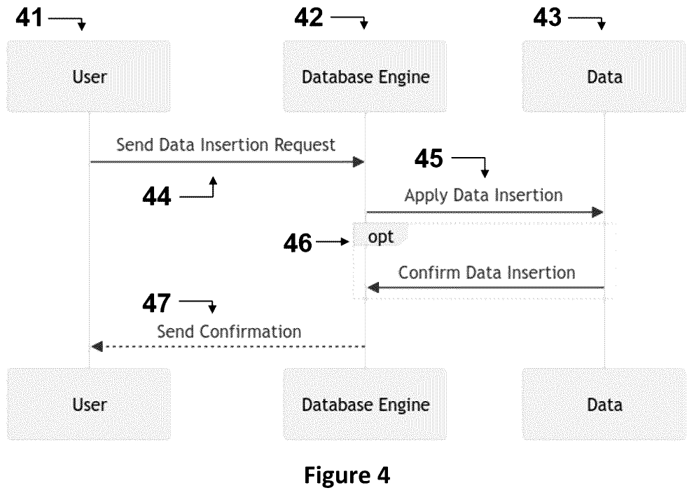

The next three drawings, FIG. 4 to FIG. 6, show example sequence diagrams of various manipulation mechanisms for the data in the vector database, including vector data and non-vector data. These manipulation mechanisms include the insertion, deletion, and modification of data in the vector database.

FIG. 4 is an example sequence diagram of inserting data into the database. In the diagram, a user 41 sends a data insertion request 44 to the database engine 42 of the vector database. The database engine 42 then inserts the appropriate data 45 into the existing data 43. Confirmation of the data being inserted is an optional step 46. If successful, the database engine 42 sends confirmation 47 to the user 41 that the data has been inserted.

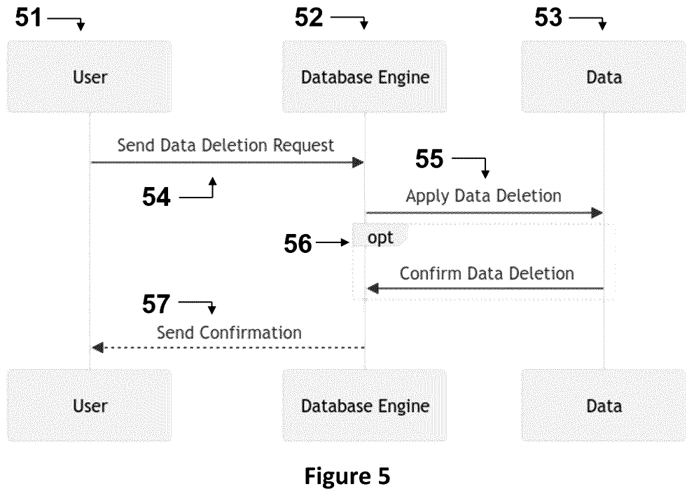

FIG. 5 is an example sequence diagram of deleting data from the database. In the diagram, a user 51 sends a data deletion request 54 to the database engine 52 of the vector database. The database engine 52 then deletes the appropriate data 55 from the existing data 53. Confirmation of the data being deleted is an optional step 56. If successful, the database engine 52 sends confirmation 57 to the user 51 that the data has been deleted.

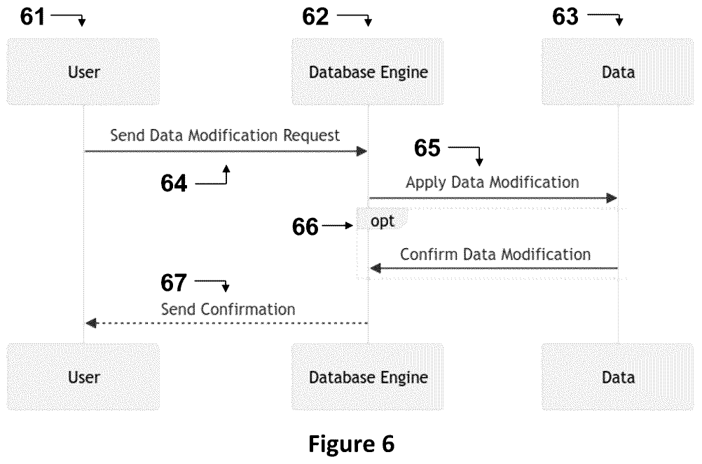

FIG. 6 is an example sequence diagram of modifying data in the database. In the diagram, a user 61 sends a data modification request 64 to the database engine 62 of the vector database. The database engine 62 then applies the appropriate data modification 65 to the data 63. Confirmation of the data being modified is an optional step 66. If successful, the database engine 62 sends confirmation 67 to the user 61 that the data has been modified.

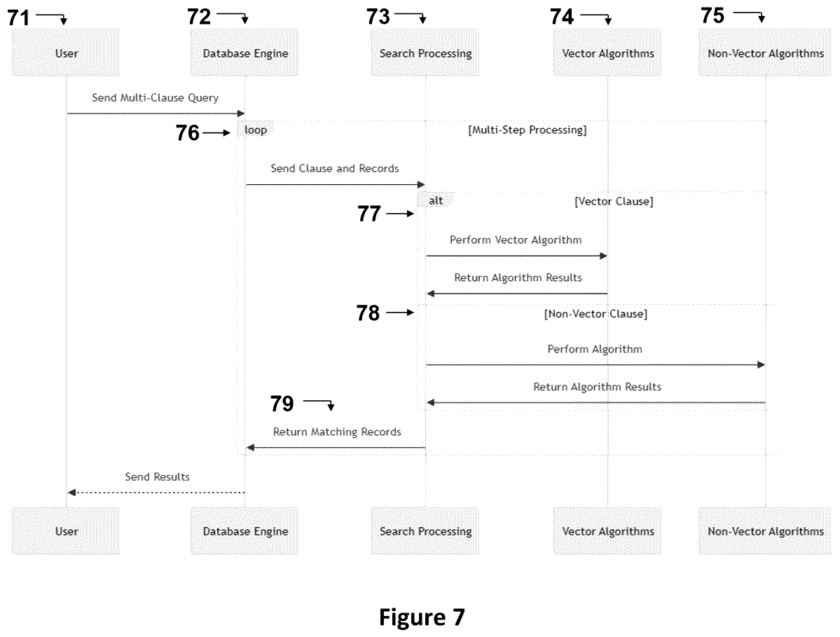

FIG. 7 is a sequence diagram of an example process for querying the vector database, based on both vector data and non-vector data characteristics and relations, demonstrating how search and retrieval algorithms are utilized. In the diagram, an interaction is initiated by a user 71 sending a query to the database engine 72 of the vector database. The query may have one or many clauses for the database engine to process. Using multi-step processing in loop 76 over the clauses, the database engine sends each clause and the relevant data records to the search processing component 73 of the vector database. In each iteration of the loop, the search processing component may use algorithms on either vector data or non-vector data. For clauses with vector data 77, the search processing component 73 performs algorithms designed for vector data 74. For clauses without vector data 78, the search processing component 73 performs algorithms designed for other supported data types in the database engine 75. At the end of each iteration in the loop, the search processing component 73 may return the matching records 79 to the database engine 72. After the iterations of the multiple-step processing loop 76 are complete, the database engine 72 of the vector database sends the results to the user 71.

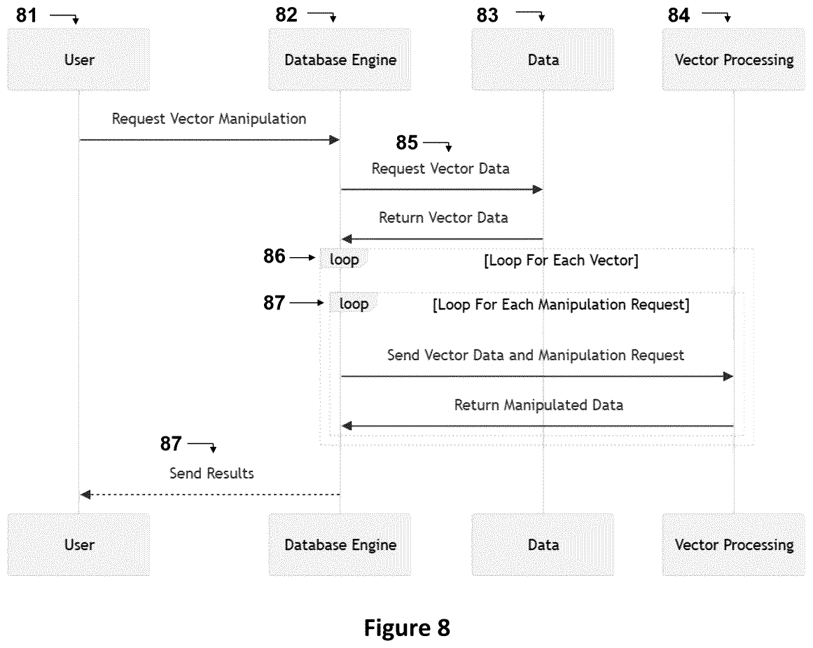

FIG. 8 is an example sequence diagram showing how a vector may be manipulated. In this drawing, user 81 sends a request to the database engine 82 of the vector database that for a vector or group of vectors to be manipulated or changed. The database engine 82 then requests the appropriate vector data 85 from the overall data 83 of the vector database, if it exists. Further processing is performed on each individual vector in the vector data, in loop 86.

For each individual vector, and for each manipulation in the user's 81 original request 87, the database engine 82 sends the individual vector data and the specific manipulation request for further vector algorithm processing 84 in loop 87. After vector algorithm processing 84, the processed vector data is returned to the database engine 82 for the next iteration of the manipulation loop 87, if another iteration exists. After the manipulation loop 87 is complete, the next individual vector is processed. After all appropriate vectors have been processed, results are sent back 87 to the user 81. Examples of such manipulation requests may include scaling the vector by a numeric value, changing the numeric type of the vector, quantizing the vector to fit in an integer, or otherwise manipulating the vector values or vector metadata.

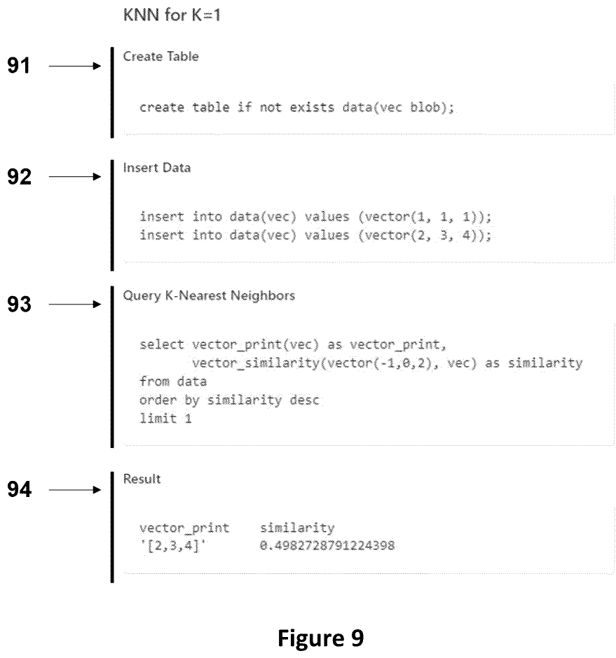

FIG. 9 is an example database query for a nearest-neighboring vector, using the k-nearest-neighbor algorithm with cosine similarity. In this example, structured query language (SQL) syntax is used to create a table, fill it with vector data, and then query that vector data using vector algorithms. The example starts with creating a table 91 with a column dedicated for vector data. Next, the example inserts two vectors 92 into the table: a vector with values “[1, 1, 1]” and a vector with values “[2, 3, 4]”. Afterwards, a query 93 is issued to the vector database requesting that the nearest-neighboring vector to a vector with values “[−1, 0, 2]” be returned, using cosine similarity as the measure for the nearest-neighbor. The results of this query 94 show that the vector with values “[2, 3, 4]” is the most similar of the vectors inserted into the table in step 92.

The example query in FIG. 9 uses the Structured Query Language (SQL) terminology of SQLite. SQLite is a lightweight software implementation of a SQL database. The example query utilizes functions which are not accessible with the standard SQLite database engine, such as “vector” in part 92, which creates a new vector for use by the query, “vector_print” in part 93, which returns the string representation of a vector, and “vector_similarity” in part 93, which compares two vectors using cosine similarity. These functions are examples of algorithmic components of the invention and their associated query language equivalents.

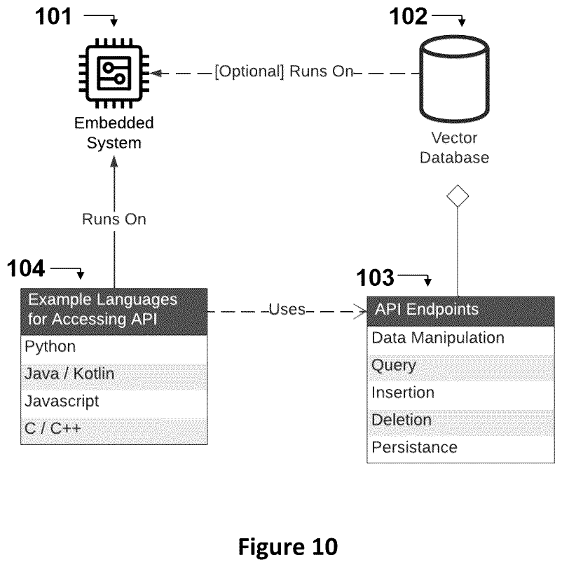

FIG. 10 illustrates how the vector database 102 for embedded systems 101 can be integrated with an application programming interface (API). In the drawing, vector database 102 has API endpoints 103 to facilitate third-party programming integrations. The endpoints include access to the functionality of the vector database described in earlier drawings, including data manipulation, insertion, deletion, and the ability to query data and persist, or store, the data to a file. The endpoints may be accessed by different programming language libraries 104 commonly used on embedded systems 101. The drawing lists examples of these languages as Python, Java, Kotlin, JavaScript, C, and C++. Additionally, the vector database 102 is shown as optionally running on an embedded system 101 housing the programming languages 104 calling its API endpoints 103. This is optional because the vector database 102 can also run on a different device and be accessed through data transmission, such as through internet communication.

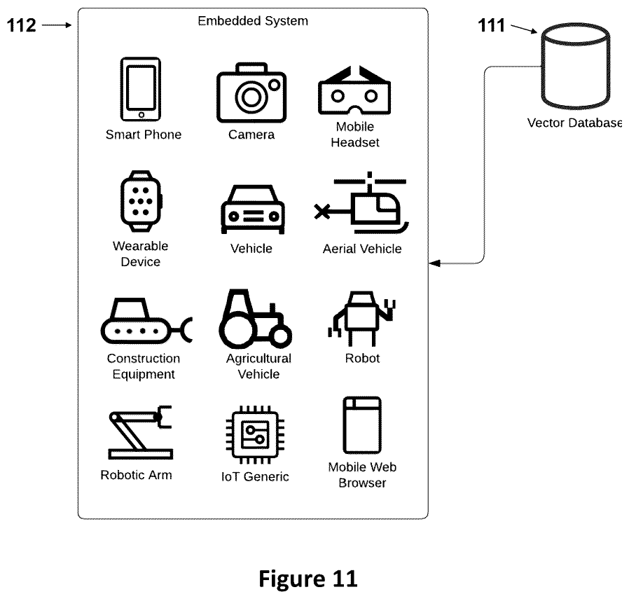

FIG. 11 illustrates the deployment of the vector database 111 on various examples of embedded systems 112. The examples include a smart phone, a camera, a mobile headset, a wearable device, different types of vehicles, a robot and robotic arm, a mobile web browser, and a generic Internet-of-Things (IoT) device. The wearable device may be a smartwatch. The mobile headset may be a virtual reality headset. The different types of vehicles include large vehicles, such as a truck, an agricultural vehicle, an aerial vehicle, and construction equipment. The vector database 111 is designed to run on any of the aforementioned examples of embedded systems 112, enabling access to and usage of the data without a requirement for internet or transmission-based connections to an external source.

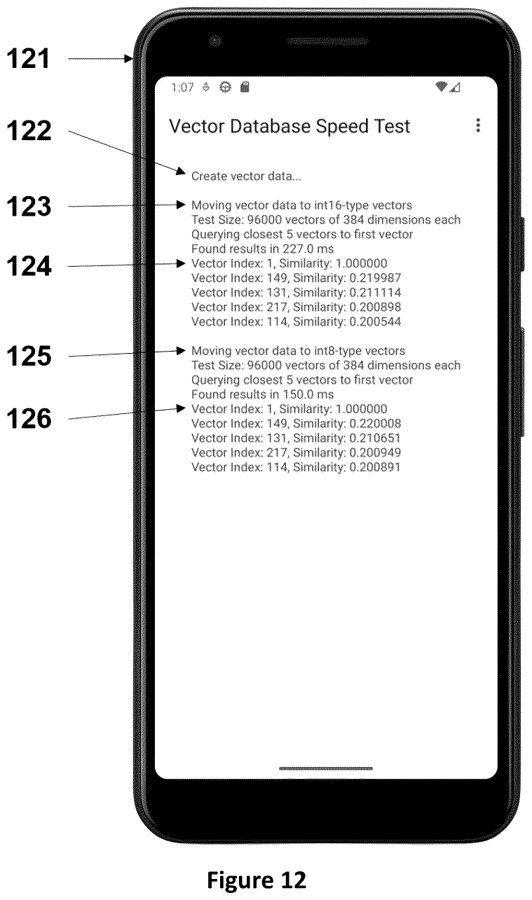

FIG. 12 is an example of the vector database running on a smartphone 121. In this drawing, the vector database is running locally on an Android smartphone 121 inside of an application. The application is a speed test to determine how fast vector similarity search can be performed using different numeric types of vectors. Initially, the application creates randomized numbers to create vector data 122. There are 96,000 vectors in this test, each having 384 dimensions, which is a common dimensionality of vectors in Artificial Intelligence applications.

In the first speed test, the data is stored in vectors having a numeric type of “int16” in step 123. A K-nearest-neighbor (KNN) search algorithm 124, with “k=5”, is performed using cosine similarity on the vectors and the results are listed in order with each vector's index and similarity score. The total time for performing the KNN algorithm is 227 milliseconds.

In the second speed test, the data is stored in vectors having a numeric type of “int8” in step 125. A KNN search algorithm 126, with “k=5”, is performed using cosine similarity on the vectors and the results are listed in order with each vector's index and similarity score. The total time for performing the KNN algorithm is 150 milliseconds.

In FIG. 12, it is evident that adjusting the numeric type of the vectors changes the speed at which the KNN search algorithm is performed. However, adjusting the numeric type can also change the results of the algorithm. In the results shown in the drawing, the similarity scores in the second test 126 are slightly different from the similarity scores in the first test 124.

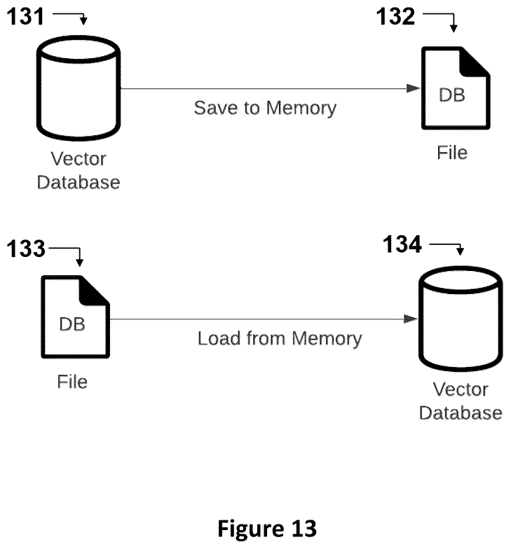

FIG. 13 is a diagram of the vector database using a file for data storage purposes. In the first part of the diagram, the vector database 131 saves, or exports, data to a database file 132. In the second part of the diagram, the vector database 134 loads, or imports, data from a database file 133. The file used for export 132 and the file used for import 133 may be stored on the same embedded system in which the vector database is running, or a different device and accessed through transmission.

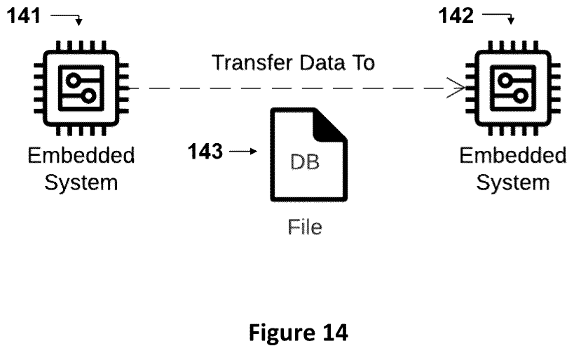

FIG. 14 is a diagram of the database data file being transferred between different embedded systems. As shown above in FIG. 13, the vector database imports and exports the data to a database file. This file does not need to remain on a single device. In this drawing, a database file 143, which stores data for the vector database, is transferred from a first embedded system 141 to a second embedded system 142. On each embedded system, separate copies of the database file may be used as described in previous drawings, such as by a vector database for inserting, deleting, querying, and manipulating the data.

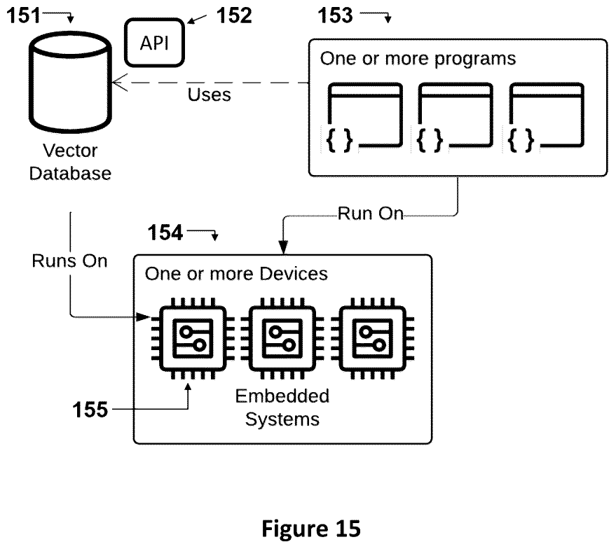

FIG. 15 illustrates the vector database 151 being used by multiple programs. In this drawing, the vector database 151 provides an application programming interface (API) 152 that can be used by one or more different programs 153. The API 152 can be used concurrently by the different programs. The vector database 151 runs on an embedded system 155 and the different programs 153 run on one or more embedded systems 154.

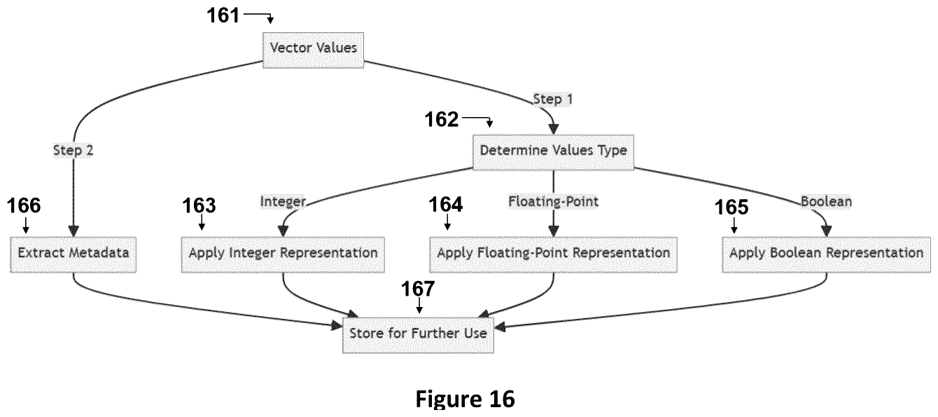

FIG. 16 is a drawing showing an example of how to process a vector for use in the vector database. In the drawing, the process starts with vector values 161.

The first step of the process in FIG. 16 is to determine which numeric type to use for the vector values 162, such as deciding between different integer types, floating-point types, or Boolean values. If the values should be represented as integers, apply the appropriate integer representation to them 163. If the values should be represented as floating-point values, apply the appropriate floating-point value representation to them 164. If the values should be represented as Boolean values, apply Boolean representation to them 165. The process as displayed is for demonstration purposes, and may also include other value types or more specific types of integers and floating-points values, such as int8, int16, int32, int64, float32, and float64.

The second step of the process in FIG. 16 is to extract vector metadata 166 that will be stored in the vector database alongside the vector values. In previous drawings, examples of this vector metadata 166 included vector length and vector magnitude.

The final step of the process in FIG. 16 is to store the processed data 167. The data to store includes the vector values and numeric type from the first step and the extracted vector metadata 166 from the second step.

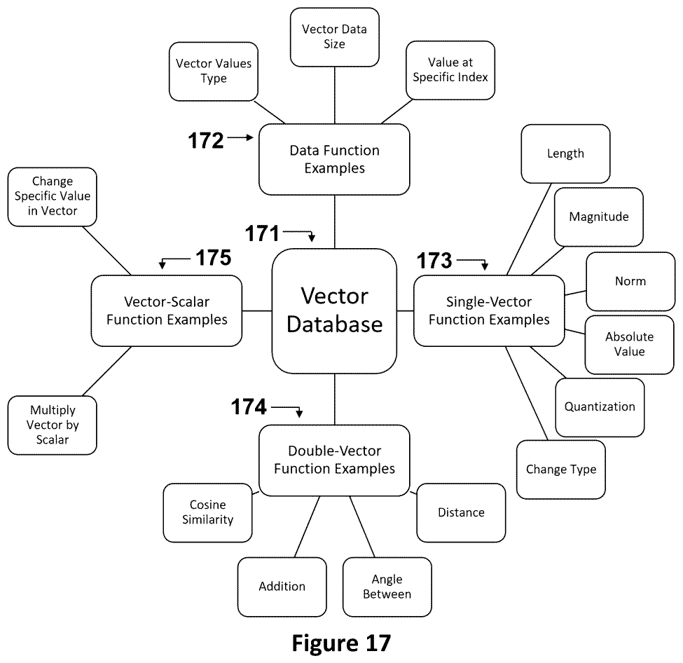

FIG. 17 is a diagram of different examples of functions available in the vector database 171 that are used to process and query vector data. In the diagram, the functions are split into four major categories. The first category is Data Function Examples 172, which includes functions related to attributes of the vectors data, such as the vector numeric type, the data size, for example in bytes, and extracting a vector's value at a specific index. The second category includes functions on single vectors 173, such as finding a vector's length, magnitude, norm, or changing the values in the vector to be absolute. This category also includes changing a vector's numeric type and applying vector quantization, which is a method of adjusting the vector values to fit a different numeric type.

In the diagram of FIG. 17, the third category is functions on two vectors 174. This category may include finding the distance between vectors, the angle between vectors, the cosine similarity between vectors, or adding the vectors to create a new vector. The fourth category is functions which combine vector data and scalar data 175. This category includes multiplying the values of a vector by a scalar or changing the value of a vector at a specific index to a different scalar value.

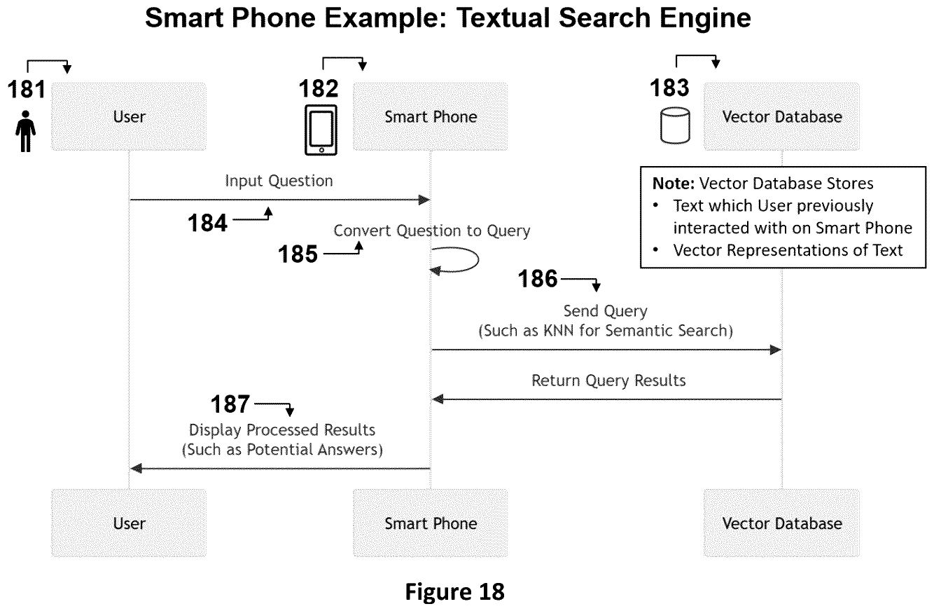

The next four drawings, FIG. 18 to FIG. 21, are sequence diagrams of various examples of the vector database as part of an embedded system. Said embedded systems in the examples are a smartphone, a camera, a robotic arm, and a vehicle. The vector database is used in the examples to perform a textual semantic similarity search, an image-based semantic distance search, a positional nearest neighbor search, and a pattern matching search. These four drawings are given as examples, and not by way of limitation to the proposed invention.

FIG. 18 is a sequence diagram showing an example of vector database 183 as part of a textual semantic search engine on a smartphone 182. In this example, vector database 183 stores text which user 181 has previously interacted with on smartphone 182 and the vector representation of said text. In the diagram, user 181 inputs a question 184 into smartphone 182. Smartphone 182 then converts the question into a query 185 and sends the query 186 to vector database 183. An example query for a semantic search engine may comprise a K-nearest-neighbor query that searches for text chunks which have the closest semantic meanings to the words in a question. The results to the query are sent from vector database 183 to smartphone 182 and then are processed, such as by rewording the results as textual answers, and displayed 187 to user 181.

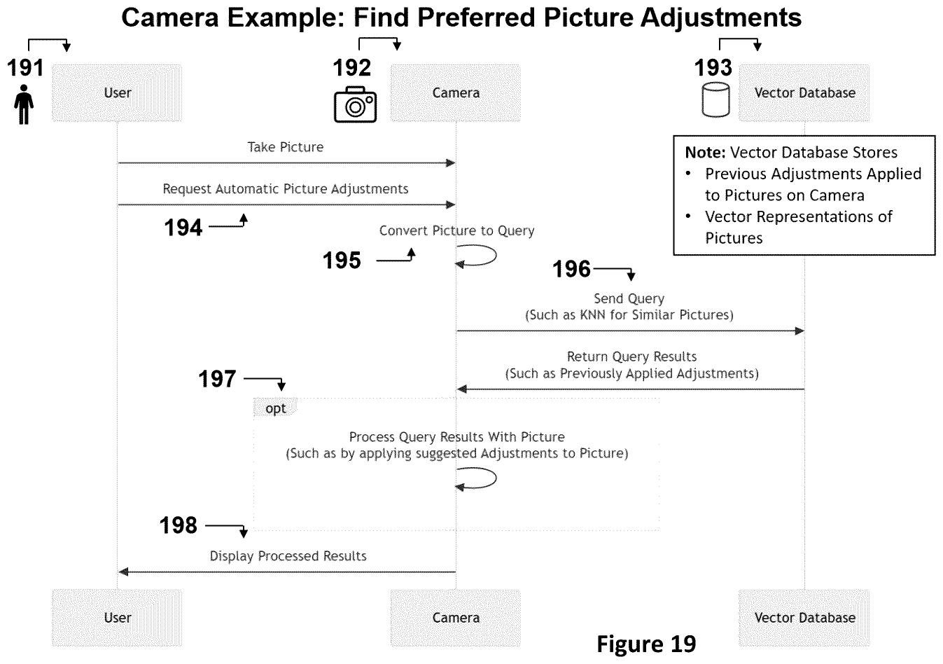

FIG. 19 is a sequence diagram showing an example of vector database 193 as part of a recommendation algorithm on a camera 192 to find preferred picture adjustments using previously chosen adjustments. In this example, vector database 193 stores the adjustments which were performed on previously captured pictures on camera 192 and the vector representation of said pictures. In the diagram, user 191 takes a picture and requests that camera 192 find adjustments for it. Camera 192 then converts the picture into a query 195 and sends query 196 to vector database 193. An example query may comprise performing a K-nearest-neighbors similarity search to find which previous pictures are most like the picture taken by user 191. The results of the query, such as adjustment mechanisms to previous pictures, are sent from vector database 193 to camera 192 and then are optionally processed 197 with the picture taken by user 191. Finally, the processed results are shown to user 191 in step 198.

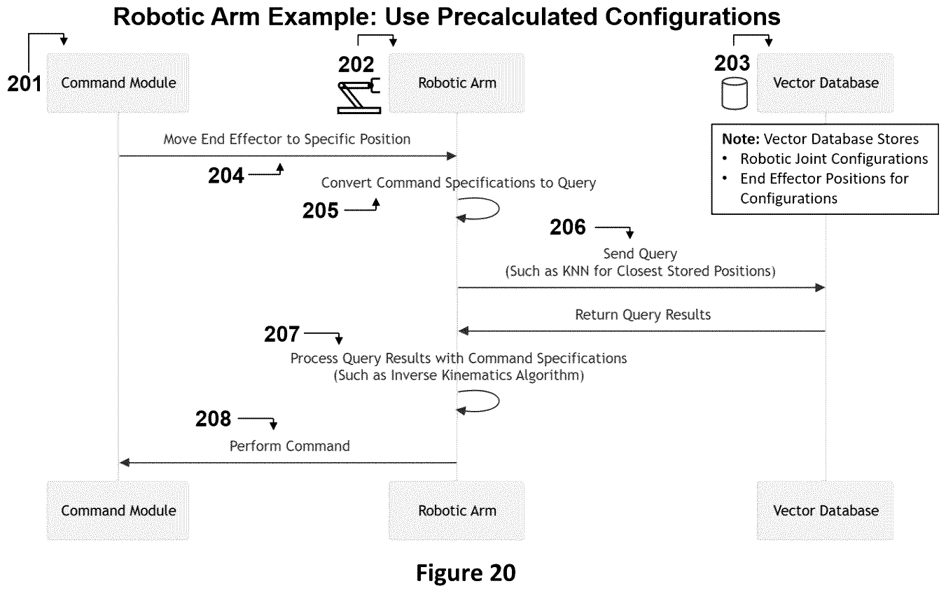

FIG. 20 is a sequence diagram showing an example of vector database 203 being used to help position robotic arm 202. In this example, vector database 203 stores precalculated robotic joint positions and the associated end effector positions of these configurations. In the diagram, command module 201 orders robotic arm 202 to move its end effector to a specific position 204. Robotic arm 202 then converts the command specifications, such as the starting position of the end effector or the target position of the end effector, or both, to a query 205 and sends the query 206 to vector database 203. An example query may comprise performing a distance search to find which stored configurations are closest to the starting position or the target position, or both. The results to the query are sent from vector database 203 to robotic arm 202 and then are processed 207 with the command specifications, for example to perform more accurate inverse kinematics calculations. Finally, the processed results are used by robotic arm 202 to perform the ordered command 208.

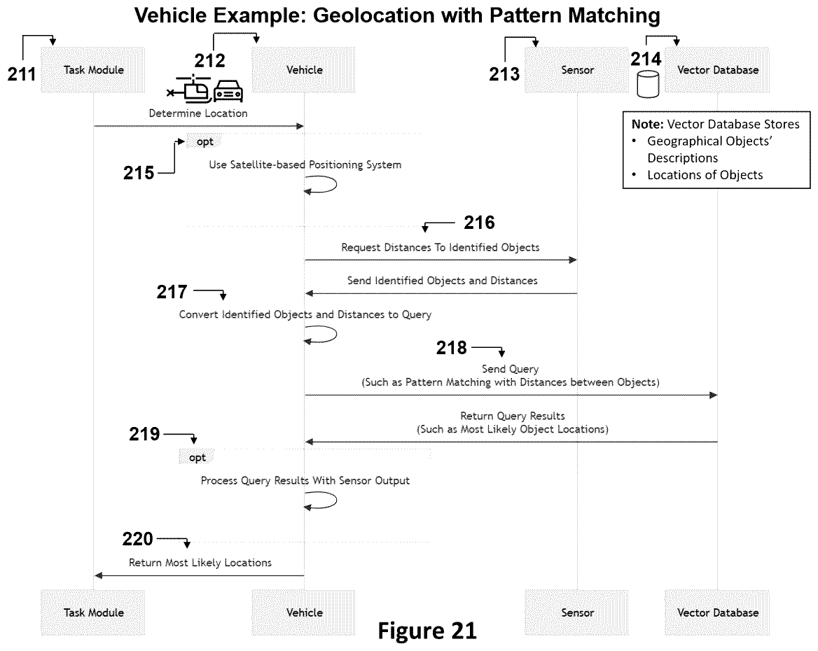

FIG. 21 is a sequence diagram showing an example of vector database 214 being used by vehicle 212 for geolocation. In this example, real-world geographical objects have been previously mapped to locations. Vector database 214 stores said geographical objects' descriptions as non-vector data and their locations as vectors. In the diagram, command module 211 requests vehicle 212 to determine its location. Optionally, the vehicle may use satellite-based positioning systems 215, such as the Global Positioning System (GPS), to determine its location. However, satellite-based positioning systems are not always available or accurate, for example in areas with electromagnetic interference. Therefore, vehicle 212 improves its determined location using sensor 213 and vector database 214.

In FIG. 21, to determine the location of vehicle 214 a request is sent to sensor 213 to identify nearby objects and return the measured distance to them 216. An example of such a sensor is a wireless radio frequency device, such as a Wi-Fi or a Bluetooth device, which can measure an approximate distance to uniquely identifiable devices around it. Another example of such a sensor is a smart camera which can classify different types of objects, such as through machine learning algorithms, and their distances from the camera. In the diagram, sensor 213 receives the request and returns the resulting identified object descriptions and distances.

Vehicle 214 then converts the object descriptions and distances to a query 217 and sends the query 218 to vector database 214. An example query may comprise performing a relational search on the distance between several objects and returning the set of objects most like the ones identified by sensor 213. The results to the query, such as the set of objects' locations, are sent from vector database 214 to vehicle 212 and then are processed 219 with the original sensor output. Finally, the processed results are sent 220 by vehicle 212 to command module 211.

I claim:

1. A method for managing vector data within a vector database, comprising the steps of:
storing vector data in a centralized vector database as digital representations of vector values;
associating metadata to each stored vector;
linking at least one non-vector data field capable of storing non-vector data to each vector;
wherein the metadata includes at least one of the length of the vector, the magnitude of the vector, the numerical type of the vector, or the memory allocation size of the vector; and
wherein the non-vector data field is at least one of text fields, numeric fields, or general use memory (blob) fields.

2. The method of claim 1, comprising the further steps of:
inserting vector data into the vector database;
inserting metadata associated with a stored vector into the vector database;
inserting non-vector data linked to a stored vector into the vector database;
deleting metadata associated with a stored vector;
deleting non-vector data linked to a stored vector;
deleting a stored vector, including its associated metadata and its linked non-vector data;
modifying a stored vector in the vector database;
modifying metadata associated with a stored vector; and
modifying non-vector data linked to a stored vector.

3. The method of claim 1, comprising the further steps of:
searching and retrieving stored vector data;
searching and retrieving metadata associated with the stored vector; and
searching and retrieving non-vector data linked to the stored vector;
wherein the searching and retrieving of stored vector data, the metadata associated with the stored vector data, and the non-vector data linked to the stored vector is performed with a query language.

4. The method of claim 1, comprising the further step of:
creating application programming interface (API) endpoints to facilitate third-party integration with the vector database.

5. The method of claim 1, comprising the further step of:
running the vector database on at least one of an embedded system, a mobile device, a handheld device, a web browser, a robotic apparatus, a vehicle, a wearable device, a mobile headset, or internet-of-things (IoT) device;
wherein the handheld device is a camera;
wherein the vehicle is one of an automobile, a train, an airplane, a boat, or an industrial vehicle;
wherein the mobile headset is one of a Virtual Reality headset, an augmented reality headset or smart glasses; and
wherein the IoT device is one of a smart speaker, a smart central heating system, or a smart door lock.

6. The method of claim 1, further comprising the steps of:
saving the vector database data for later use;
loading the vector database data from a saved location;
allowing the vector database data to be transferred between software processes;
allowing the vector database data to be transferred between hardware devices;
enabling access to the vector database data by a single software process; and
enabling access to the vector database data by more than one software process.

7. The method of claim 1,
wherein the stored vector data is comprised of individual numbers; and
wherein the individual numbers are at least one of integers; floating-point values; or Boolean values.

8. The method of claim 1, further comprising the steps of:
performing an operation on the stored vector data;
wherein the operation is at least one of a mathematical operation for extracting vector length, a mathematical operation for extracting vector magnitude; a mathematical operation for determining proximity between at least two stored vectors; a mathematical operation for determining disparity between at least two stored vectors; or an algorithmic operation for extracting and comparing metadata associated with at least two stored vectors.
